(19) United States
(12) Patent Application Publication
(10) Pub. No.: US 2020/0250544 A1
(43) Pub. Date: Aug. 6, 2020

(54) LEARNING METHOD, STORAGE MEDIUM, AND LEARNING APPARATUS

(71) Applicant: FUJITSU LIMITED, Kawasaki-shi (JP)

(72) Inventors: TAKASHI KATOH, Kawasaki (JP); Kento UEMURA, Kawasaki (JP); Suguru YASUTOMI, Kawasaki (JP); Takuya Takagi, Kawasaki (JP); KEN KOBAYASHI, Setagaya (JP); Akira URA, Yokohama (JP); Kenichi KOBAYASHI, Kawasaki (JP)

(73) Assignee: FUJITSU LIMITED, Kawasaki-shi (JP)

(21) Appl. No.: 16/780,975

(22) Filed: Feb. 4, 2020

(30) Foreign Application Priority Data
Feb. 5, 2019 (JP) 2019-018829

(51) Int. Cl. G06N 3/08; G06N 3/04; G06N 20/00; G06N 5/04

(52) U.S. Cl. CPC G06N 3/088; G06N 5/04; G06N 20/00; G06N 3/0454

(57) ABSTRACT

A learning method executed by a computer, the learning method includes inputting a first data being a data set of transfer source and a second data being one of data sets of transfer destination to an encoder to generate first distributions of feature values of the first data and second distributions of feature values of the second data; selecting one or more feature values from among the feature values so that, for each of the one or more feature values, a first distribution of the feature value of the first data is similar to a second distribution of the feature value of the second data; inputting the one or more feature values to a classifier to calculate prediction labels of the first data; and learning parameters of the encoder and the classifier such that the prediction labels approach correct answer labels of the first data.

### CROSS-REFERENCE TO RELATED APPLICATION

This application is based upon and claims the benefit of priority of the prior Japanese Patent Application No. 2019-18829, filed on Feb. 5, 2019, the entire contents of which are incorporated herein by reference.

### FIELD

The embodiment discussed herein relates to a learning method and so forth.

### BACKGROUND

It is assumed that a first machine learning model and a second machine learning model different from the first machine learning model exist and, while the first machine learning model may be learned with a first data set and the second machine learning model is learned with a second data set that is different in distribution (nature) of data from the first data set. Here, a case in which a first data set with a label is sometimes applied to learning of a second machine learning model, and such learning is called transductive transfer learning. In the transductive transfer learning, a plurality of data sets of an application destination sometimes exist. In the following, such transductive transfer learning is referred to as transfer learning.

In the transfer learning, in the case where a first data set and a second data set are different in nature, if the second model that uses a feature value unique to the first data set is generated, the accuracy of the second machine learning model degrades. On the other hand, there is a related art by which learning is performed using a distribution of a feature value that is common between domains of a first data set and a second data set as a clue to suppress accuracy degradation of a feature value unique to the first data set.

FIG. 14 is a view illustrating an example of a related art. A machine learning model depicted in FIG. 14 includes an encoder 10a and a classifier 10b. The encoder 10a calculates a feature value based on inputted data and a parameter set to the encoder 10a. The classifier 10b calculates a prediction label according to the feature value based on the inputted feature value and the parameter set to the classifier 10b.

The related art performs learning (transfer learning) of parameters of the encoder 10a and the classifier 10b using transfer source data xs and transfer destination data xt1. For example, in the case where a machine learning model different from the machine learning model depicted in FIG. 14 is learned, the learning may be performed using the transfer source data xs and a label ys is set. On the other hand, although the transfer destination data xt is data that may be used when the machine learning model depicted in FIG. 14 is learned, it is assumed that the transfer destination data xt does not have a label set thereto.

FIG. 15 is a view depicting an example of transfer source data and transfer destination data. Referring to FIG. 15, the transfer source data (data set) includes a plurality of transfer source data xs1 and xs2, to each of which a transfer source label is set. The transfer source data may include transfer source data other than the transfer source data xs1 and xs2.

The transfer source label corresponding to the transfer source data xs1 is a transfer source label ys1. The transfer source label corresponding to the transfer source data xs2 is a transfer source label ys2. In the following description, the transfer source data xs1 and xs2 are sometimes referred to collectively as transfer source data xs. The transfer source labels ys1 and ys2 are collectively referred to as transfer source labels ys.

Transfer destination data (data set) includes a plurality of transfer destination data xt1.1 and xt1.2 that have the same nature and do not have a label set thereto. The transfer destination data may include transfer destination data other than the transfer destination data xt1.1 and xt1.2. The transfer destination data xt1.1 and xt1.2 are collectively referred to as transfer destination data xt1.

Referring to FIG. 14, if transfer source data xs is inputted to the encoder 10a, a feature value zs is calculated. If transfer destination data xt is inputted to the encoder 10a, a feature value zt1 is calculated. The feature value zs is inputted to the classifier 10b, and a decision label ys' is calculated. The feature value zt1 is inputted to the classifier 10b, and a decision label yt1′ is calculated.

In the related art, upon learning, a parameter of the encoder 10a is learned such that the error (similarity loss) between a distribution of the feature value zs and a distribution of the feature value zt1 is minimized. Further, in the related art, a parameter of the encoder 10a and a parameter of the classifier 10b are learned such that the error (supervised loss) between the decision label ys' and the transfer source label ys is minimized. As the related art, Tianchun Wang, Xiaoming Jin, Xiaojun Ye “Multi-Relevance Transfer Learning,” Sean Rowan “Transducive Adversarial Networks (TAN)” and so forth are disclosed.

### SUMMARY

According to an aspect of the embodiment, a learning method executed by a computer, the learning method includes inputting a first data set being a data set of transfer source and a second data set being one of data sets of transfer destination to an encoder to generate first distributions of feature values of the first data set and second distributions of feature values of the second data set; selecting one or more feature values from among the feature values so that, for each of the one or more feature values, a first distribution of the feature value of the first data set is similar to a second distribution of the feature value of the second data set; inputting the one or more feature values to a classifier to calculate prediction labels of the first data set; and learning parameters of the encoder and the classifier such that the prediction labels approach correct answer labels of the first data set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating processing of a learning apparatus according to a working example;

FIG. 2 is a view illustrating processing of a selection unit according to the present working example;

FIG. 3 is a view (1) illustrating a process of processing of a learning apparatus according to the present working example;

FIG. 4 is a view (2) illustrating a process of processing of a learning apparatus according to the present working example;

FIG. 5 is a view (3) illustrating a process of processing of a learning apparatus according to the present working example;

FIG. 6 is a view (4) illustrating a process of processing of a learning apparatus according to the present working example;

FIG. 7 is a functional block diagram depicting a configuration of a learning apparatus according to the present working example;

FIG. 8 is a view depicting an example of a data structure of a learning data table;

FIG. 9 is a view depicting an example of a data structure of a parameter table;

FIG. 10 is a view depicting an example of a data structure of a prediction label table;

FIG. 11 is a flow chart depicting a processing procedure of learning processing of a learning apparatus according to the present working example;

FIG. 12 is a flow chart depicting a processing procedure of prediction processing of a learning apparatus according to the present working example;

FIG. 13 is a view depicting an example of a hardware configuration of a computer that implements functions similar to those of a learning apparatus according to the present working example;

FIG. 14 is a view illustrating an example of a related art;

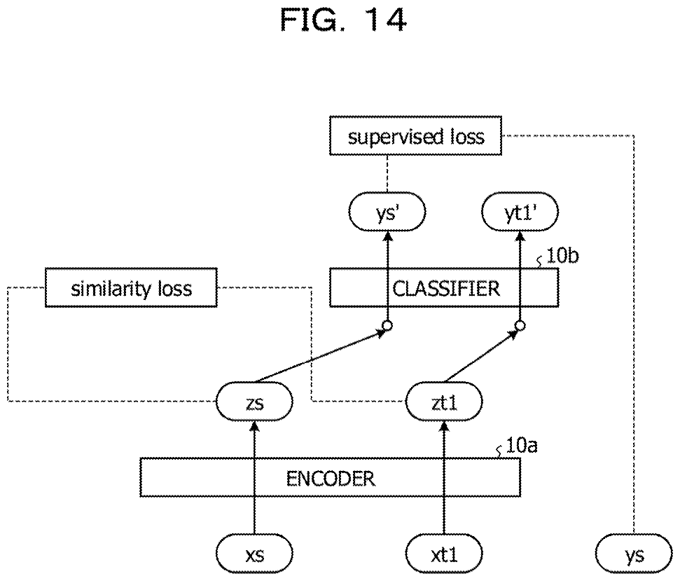

FIG. 15 is a view depicting an example of transfer source data and transfer destination data; and

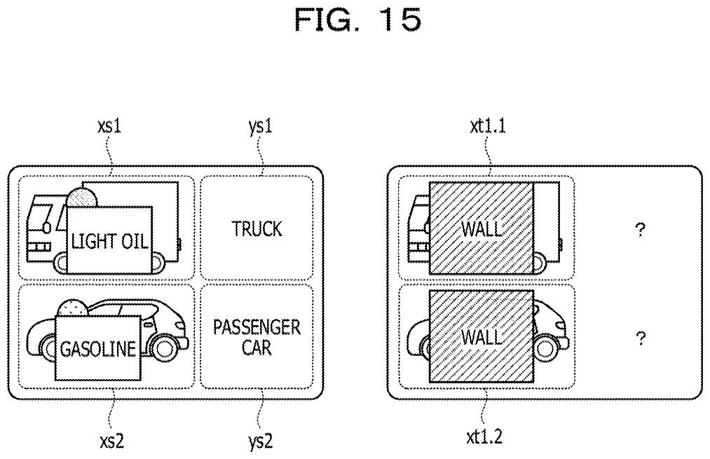

FIG. 16 is a view illustrating a problem of a related art.

### DESCRIPTION OF EMBODIMENT

However, the related art described above has a problem that the accuracy of transfer learning in which a plurality of data sets having different natures are used degrades.

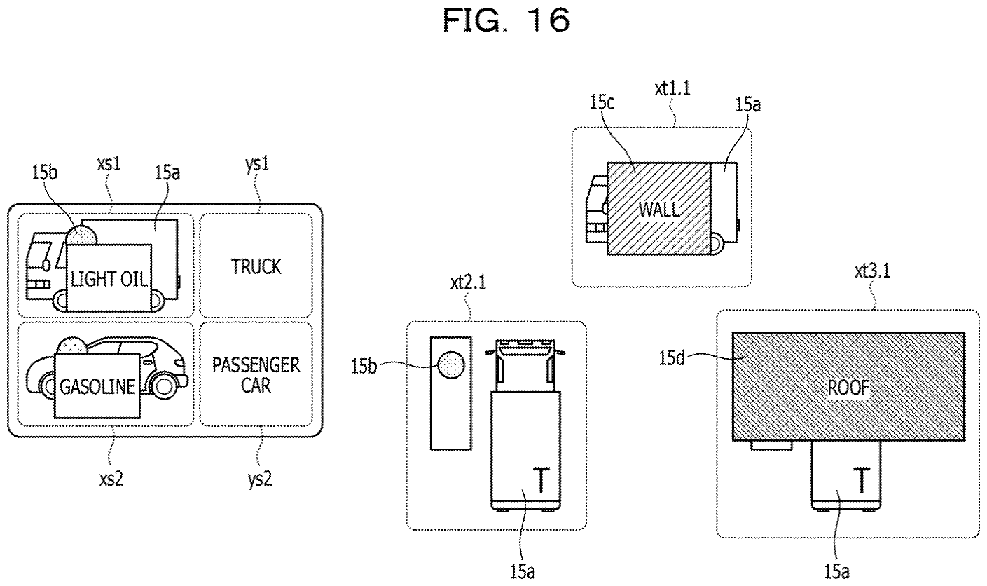

FIG. 16 is a view illustrating a problem of a related art. For example, a case is described in which a machine learning model is transfer learned using transfer source data xs1 and transfer destination data xt1.1, xt2.1, and xt3.1. The transfer destination data xt1.1, xt2.1, and xt3.1 are data sets having natures different from one another.

For example, the transfer source data xs1 includes an image of a truck 15a and an image of a lamp 15b glowing red. The transfer destination data xt1.1 includes an image of the truck 15a and an image of a wall 15c. The transfer destination data xt2.1 includes an image of the truck 15a and an image of the lamp 15b glowing red. The transfer destination data xt3.1 includes an image of the truck 15a and an image of a roof 15d.

Here, if the transfer source data xs1 and the transfer destination data xt2.1 are compared with each other, the feature that the lamp 15b is red is a useful feature for estimating a label (truck). However, according to the related art, a parameter of the encoder 10a is learned such that the error among the feature values of the transfer destination data x1.1 to x3.1 is minimized, and since the transfer destination data xt1.1 and xt3.1 do not include an image of the lamp 15b, a feature value regarding the lamp 15b is absent in the transfer destination data xt1.1 and xt3.1.

On the other hand, if the transfer destination data xt2.1 and the transfer destination data xt3.1 are compared with each other, than the feature of the character “T” included in an image of the truck 15a is a feature useful to estimate the label (truck). However, a parameter of the encoder 10a is learned such that the error among the feature values of the transfer destination data xt1.1 to xt3.1 is minimized as in the related art, and since the character “T” is not included in an image of the truck 15a in the transfer source data xs1 and the transfer destination data xt1.1, a feature value of the character “T” is absent in the transfer source data xs1 and the transfer destination data xt1.1.

For example, according to the related art, a feature value useful for label estimation of some data set is not generated, and the accuracy in transfer learning degrades.

If a machine learning model is generated for each of data sets having different natures, the amount of data that may be used for learning decreases, and therefore, learning is not performed with a sufficient data set and the accuracy in transfer learning degrades. Taking the foregoing into consideration, it is desirable to improve the accuracy in transfer learning in which a plurality of data sets having natures different from each other are used.

In the following, a working example of a learning method, a learning program, and a learning apparatus disclosed therein is described in detail with reference to the drawings. The embodiment discussed herein is not limited by the working example.

### Working Example

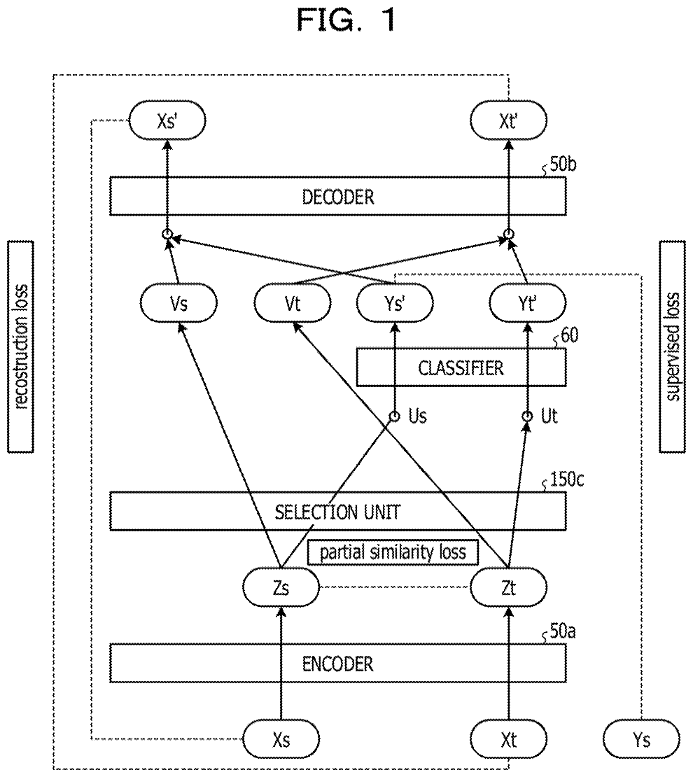

FIG. 1 is a view illustrating processing of a learning apparatus according to the present working example. The learning apparatus executes an encoder 50a, a decoder 50b, and a classifier 60. For example, the learning apparatus selects data sets Xs and Xt from a plurality of data sets having natures different from each other. For example, the learning apparatus inputs data included in the selected data sets Xs and Xt to the encoder 50a and calculates a distribution of feature values Zs according to the data included in the data set Xs and a distribution of feature values Zt according to the data included in the data set Xt.

A selection unit 150c of the learning apparatus compares the distribution of the feature values Zs and the distribution of the feature values Zt according to the data included in the data sets with each other and decides a feature value with regard to which the distributions are close to each other and another feature value with regard to which the distributions are different from each other.

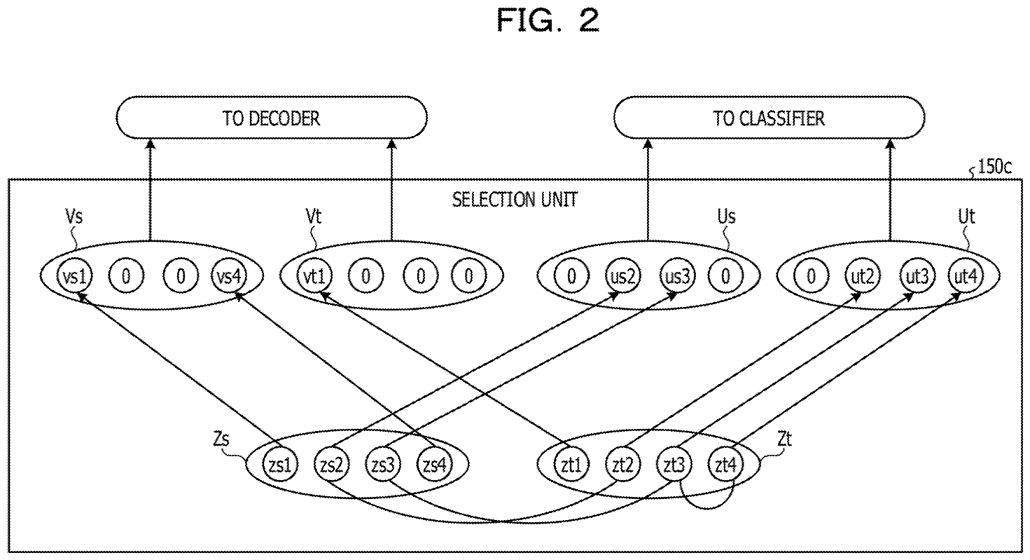

FIG. 2 is a view illustrating processing of a selection unit according to the present working example. The selection unit 150c compares the distribution of the feature values Zs and the distribution of the feature values Zt with each other and selects a feature value with regard to which the distributions partly coincide with each other. For example, it is assumed that, as a result of the distribution of the feature values zs1, zs2, zs3, and zs4 included in the feature values Zs and the distribution of the feature values zt1, zt2, zt3, and zt4 included in the feature values Zt, the distribution of the feature value zs2 and the distribution of the feature value zt2 coincide with each other (the distributions are similar to each other). Further, it is assumed that the distribution of the feature value zs3 and the distribution of the feature value zt3 coincide with each other (the distributions are similar to each other). In this case, the selection unit 150c selects the feature values zs2 and zs3 and sets the selected feature values zs2 and zs3 to a feature value Us. The selection unit 150c selects the feature values zt2 and zt3 and sets the selected feature values zt2 and zt3 to a feature value Ut.

Here, the selection unit 150c may further select, from among the feature values calculated from the same data set, a feature value having a correlation to a feature value selected due to coincidence in distribution. For example, in the case where the distribution of the feature value zt3 and the distribution of the feature value zt4 are correlated with each other, the selection unit 150c sets the feature value zt4 to the feature value Ut.

The selection unit 150c sets the remaining feature values that have not been selected by the processing described above to the feature values Vs and Vt. For example, the selection unit 150c sets the feature values zs1 and zs4 to the feature value Vs. The selection unit 150c sets the feature value zt1 to the feature value Vt.

The feature values Us and Ut depicted in FIG. 2 are inputted to the classifier 60. The feature values Vs and Vt are inputted to the decoder 50b together with class labels outputted from the classifier 60. The selection unit 150c performs correction of the signal intensity for the feature values Us and Ut and the feature values Vs and Vt similarly to Dropout.

Referring back to FIG. 1, the learning apparatus inputs the feature value Us to the classifier 60 to calculate a class label Ys′. The learning apparatus inputs the feature value Ut to the classifier 60 to calculate a class label Yt′.

The learning apparatus inputs data of the feature value Vs and the class label Ys′ together with each other to the decoder 50b to calculates reconstruction data Xs′. The learning apparatus inputs data of the feature value Vt and the class label Yt′ together with each other to the decoder 50b to calculate reconstruction data Xt′.

The learning apparatus learns parameters of the encoder 50a, the decoder 50b, and the classifier 60 such that conditions 1, 2, and 3 are satisfied.

The “condition 1” is a condition that, in the case where a data set has a label applied thereto, the prediction error (supervised loss) is small. In the example depicted in FIG. 1, the error between the label Ys applied to each data of the data set Xs and the class label Ys′ is a prediction error.

The “condition 2” is a condition that the reconstruction error (reconstruction loss) is small. In the example depicted in FIG. 1, each of the error between the data set Xs and the reconstruction data Xs′ and the error between the data set Xt and the reconstruction data Xt′ is reconstruction error.

The “condition 3” is a condition that a partial difference (partial similarity loss) between a distribution of feature values according to each data included in the data set Xs and a distribution of feature values according to each data included in the data set Xt is small.

As described with reference to FIGS. 1 and 2, according to the learning apparatus according to the present working example, a plurality of groups of distributions of feature values obtained by inputting a data set of one of a transfer source and a transfer destination to an encoder are compared with each other, and only a feature value with regard to which partial coincidence is indicated is inputted to a classifier to perform learning. Since this makes it possible for the data sets to share information of a feature value useful for labeling, the accuracy in transfer learning may be improved.

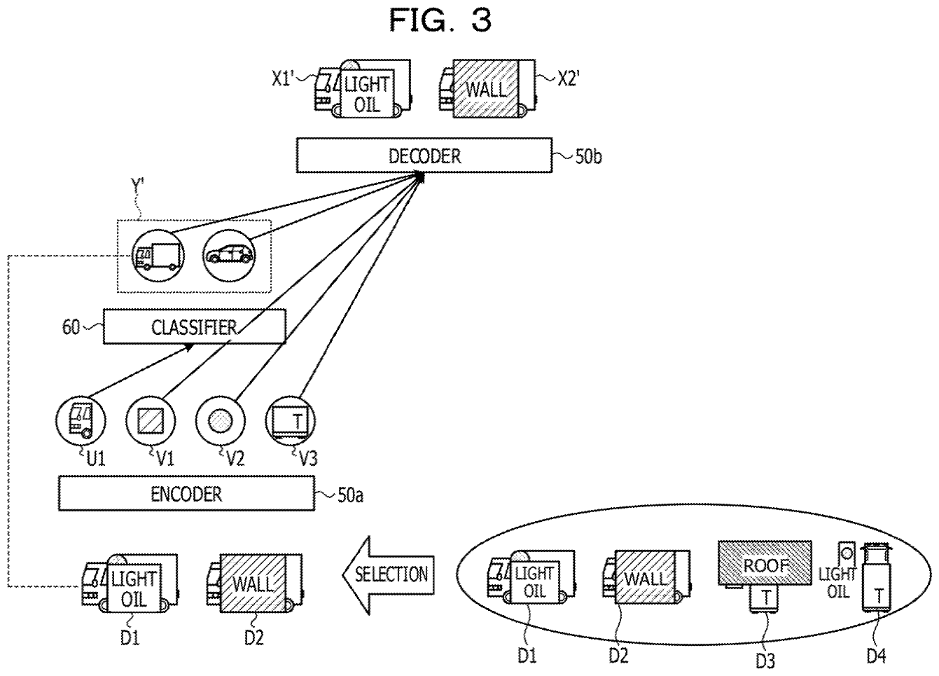

FIGS. 3 to 6 are views illustrating processes of processing of a learning apparatus according to the present working example. Description is given with reference to FIG. 3. The learning apparatus selects two data sets from among a plurality of data sets D1 to D4 having natures different from one another. It is assumed that, for example, each data included in the data set D1 has a label set therein. Further, it is assumed that each data included in the data sets D2 to D4 has no label set therein.

In the example depicted in FIG. 3, the learning apparatus selects the data sets D1 and D2 from among the plurality of data sets D1 to D4. The learning apparatus inputs data included in the selected data sets D1 and D2 to the encoder 50a to calculate a distribution of feature values according the data included in the data set D1 and a distribution of feature values according to the data included in the data set D2.

The learning apparatus compares the distribution of the feature values according to the data included in the data set D1 and the distribution of the feature values according to the data included in the data set D2 with each other to decide feature values whose distributions are close to each other and feature values whose distributions are different from each other. In the example depicted in FIG. 3, a feature value U1 is feature value whose distributions are close to each other and feature values V1, V2, and V3 are feature values whose distributions are different from each other.

The learning apparatus inputs the feature value U1 to the classifier 60 to calculate a classification result (class label) Y′. The learning apparatus inputs the classification result Y′ and the feature values V1, V2, and V3 to the decoder 50b to calculate reconstruction data X1′ and X2′. The learning apparatus determines the data set D1 as a data set with a label and calculates a prediction error between a classification result (for example, Y′) and the label of the data set D1. The learning apparatus calculates a reconstruction error between the reconstruction data X1′ (X2′) and the data included in the data set D1 (D2).

The learning apparatus learns parameters of the encoder 50a, the decoder 50b, and the classifier 60 using an error back propagation method or the like such that the conditions 1 to 3 are satisfied.

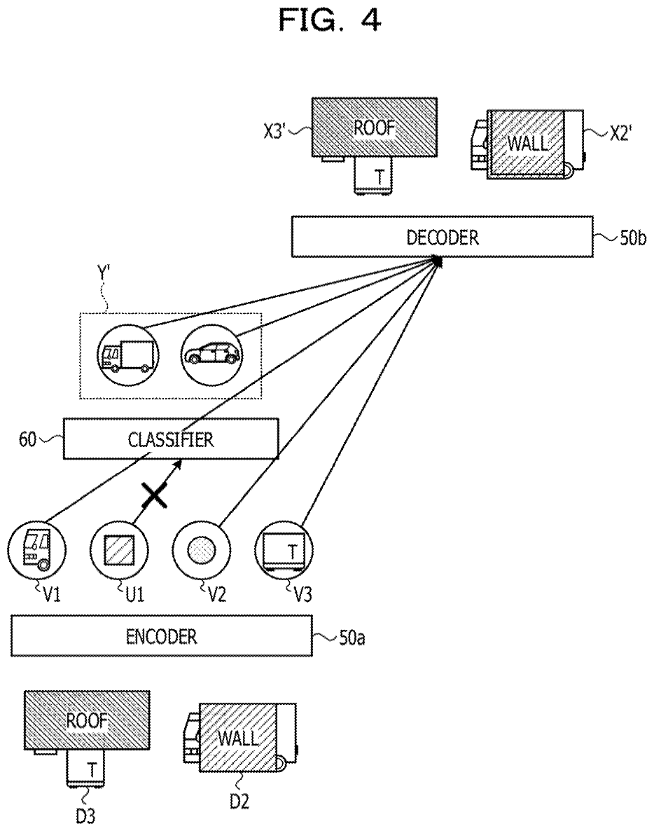

Description is given now with reference to FIG. 4. In the example of FIG. 4, the learning apparatus selects data sets D2 and D3. The learning apparatus inputs data included in the selected data sets D2 and D3 to the encoder 50a to calculate a distribution of feature values according to the data included in the data set D2 and a distribution of feature values according to the data included in the data set D3.

The learning apparatus compares the distribution of the feature values according to the data included in the data set D2 and the distribution of the feature values according to the data included in the data set D3 with each other to decide feature values whose distributions are close to each other and feature values whose distributions are different from each other. In the example depicted in FIG. 4, a feature value U1 is feature values whose distributions are close to each other and feature values V1, V2, and V3 are feature values whose distributions are different from each other.

The learning apparatus inputs the feature value U1 to the classifier 60 to calculate a classification result (class label) Y′. The learning apparatus inputs the classification result Y′ and the feature values V1, V2, and V3 to the decoder 50b to calculate reconstruction data X2′ and X3′.

The learning apparatus learns parameters of the encoder 50a, the decoder 50b, and the classifier 60 using an error back propagation method or the like such that the conditions 2 and 3 are satisfied. Here, the reconstruction error of the condition 2 increases as information for reconstructing data becomes insufficient.

The decoder 50b has a characteristic that, in the case where a result outputted from the classifier 60 is correct, reconstruction data is calculated putting weight on the output result of the classifier 60. This makes the reconstruction error smaller in the case where the reconstruction error is great. In the processing of learning of the learning apparatus, the classifier 60 does not use the feature value U1 anymore.

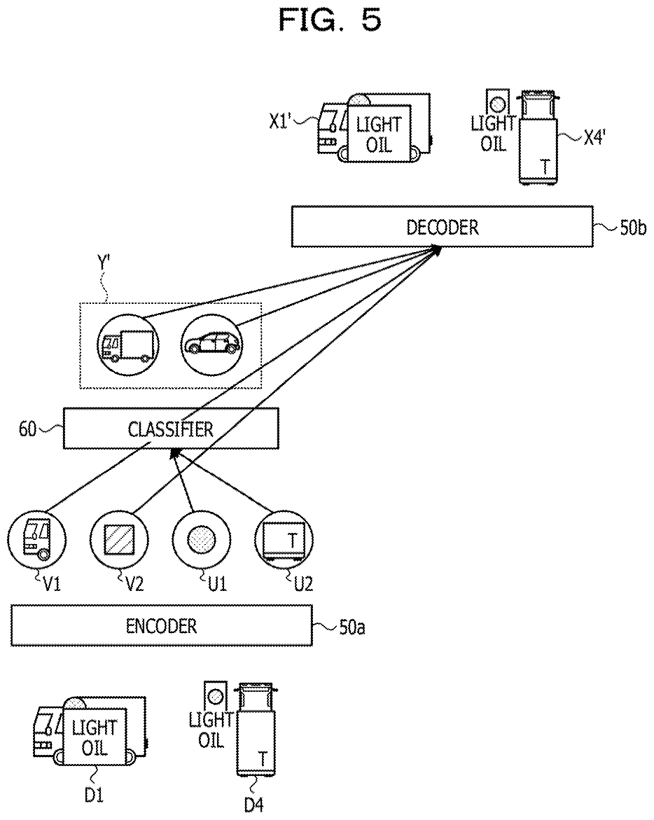

Description is given now with reference to FIG. 5. In the example of FIG. 5, the learning apparatus selects data sets D1 and D4, The learning apparatus inputs data included in the selected data sets D1 and D4 to the encoder 50a to calculate a distribution of feature values according to the data included in the data set D1 and a distribution of feature values according to the data included in the data set D4.

The learning apparatus compares the distribution of the feature values according to the data included in the data set D1 and the distribution of the feature values according to the data included in the data set D4 with each other to decide feature values whose distributions are close to each other and feature values whose distributions are different from each other. In the example depicted in FIG. 5, feature values U1 and U2 are feature values whose distributions are close to each other and feature values V1 and V2 are feature values whose distributions are different from each other. For example, the feature value U2 is a feature value having a correlation to the feature value U1.

The learning apparatus inputs the feature values U1 and U2 to the classifier 60 to calculate a classification result (class label) Y′. The learning apparatus inputs the classification result Y′ and the feature values V1 and V2 to the decoder 50b to calculate reconstruction data X1′ and X4′.

The learning apparatus learns parameters of the encoder 50a, the decoder 50b, and the classifier 60 using an error back propagation method or the like such that the conditions 1, 2, and 3 are satisfied.

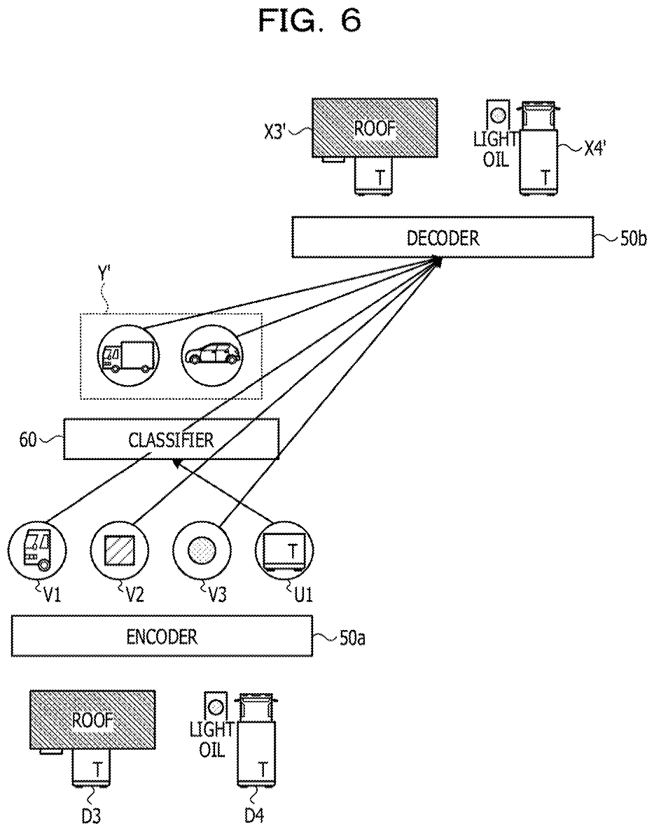

Description is given now with reference to FIG. 6. In the example of FIG. 6, the learning apparatus selects data sets D3 and D4. The learning apparatus inputs data included in the selected data sets D3 and D4 to the encoder 50a to calculate a distribution of feature values according to data included in the data set D3 and a distribution of feature values according to data included in the data set D4.

The learning apparatus compares the distribution of the feature values according to the data included in the data set D3 and the distribution of the feature values according to the data included in the data set D4 with each other to decide feature values whose distributions are close to each other and feature values whose distributions are different from each other. In the example depicted in FIG. 6, a feature value U1 is a feature value whose distributions are close to each other and feature values V1, V2, and V3 are feature values whose distributions are different from each other.

The learning apparatus inputs the feature value U1 to the classifier 60 to calculate a classification result (class label) Y′. The learning apparatus inputs the classification result Y′ and the feature values V1, V2, and V3 to the decoder 50b to calculate reconstruction data X3′ and X4′.

The learning apparatus learns parameters of the encoder 50a, the decoder 50b, and the classifier 60 using an error back propagation method or the like such that the conditions 2 and 3 are satisfied.

By repetitive execution of the processing described above by the learning apparatus, information of feature values useful for labeling between data sets having no label is shared. For example, the feature values useful for labeling correspond to the feature values U1 and U2 depicted in FIG. 5, the feature value U1 depicted in FIG. 6 or the like. In contrast, the feature values that are not useful for labeling are not used any more in the process of learning. For example, the feature value that is not useful for labeling is the feature value U1 depicted in FIG. 4.

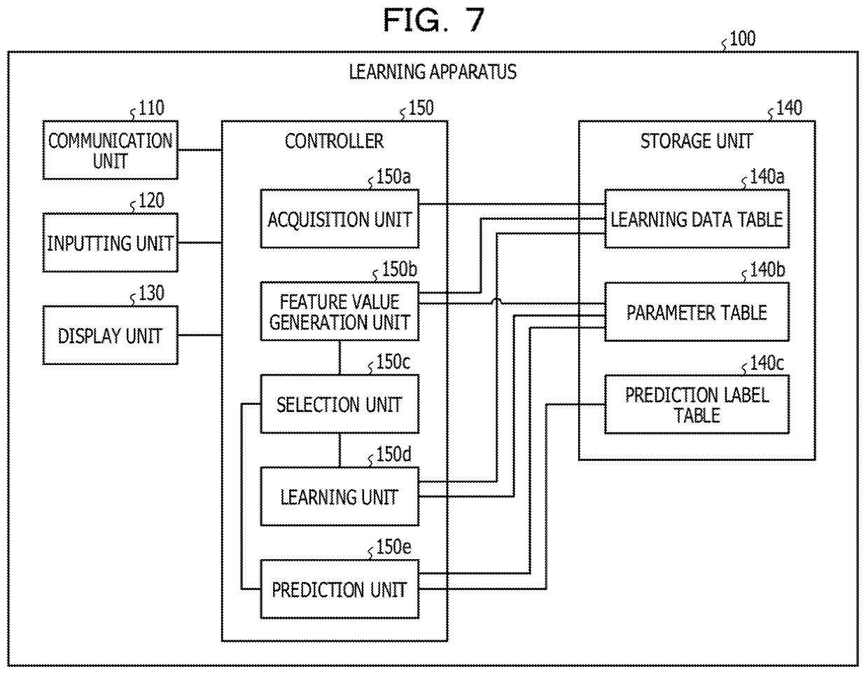

Now, an example of a configuration of the learning apparatus according to the present working example is described. FIG. 7 is a functional block diagram depicting a configuration of a learning apparatus according to the present working example. As depicted in FIG. 7, the learning apparatus 100 includes a communication unit 110, an inputting unit 120, a display unit 130, a storage unit 140, and a controller 150.

The communication unit 110 is a processor that executes data communication with an external apparatus (not depicted) through a network or the like. The communication unit 110 corresponds to a communication apparatus. For example, the communication unit 110 receives information of a learning data table 140a hereinafter described from an external apparatus or the like.

The inputting unit 120 is an inputting apparatus for inputting various kinds of information to the learning apparatus 100. For example, the inputting unit 120 corresponds to a keyboard, a mouse, a touch panel or the like.

The display unit 130 is a display apparatus that displays various kinds of information outputted from the controller 150. For example, the display unit 130 corresponds to a liquid crystal display, a touch panel or the like.

The storage unit 140 includes a learning data table 140a, a parameter table 140b, and a prediction label table 140c. The storage unit 140 corresponds to a storage device such as a semiconductor memory element such as a random access memory (RAM), a read only memory (ROM), or a flash memory or a storage apparatus such as a hard disk drive (HDD).

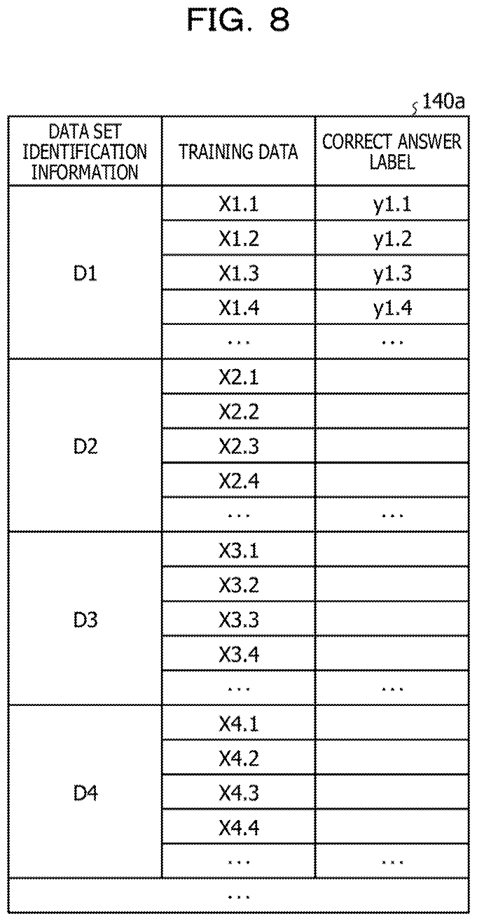

The learning data table 140a is a table that stores a transfer source data set and a transfer destination data set. FIG. 8 is a view depicting an example of a data structure of a learning data table. As depicted in FIG. 8, the learning data table 140a associates data set identification information, training data, and correct answer labels with one another. The data set identification information is information identifying the data sets. The training data are data to be inputted to the encoder 50a upon learning. The correct answer labels are labels of correct answers corresponding to the training data.

Referring to FIG. 8, a data set in regard to which information is set to the correct answer label is a data set with a label (teacher present). A data set in regard to which information is not set to the correct answer label is a data set without a label (teacher absent). For example, the data set of the data set identification information D1 is a data set with a label. The data sets of the data set identification information D2 to D4 are data sets without a label. The data sets are data sets having natures different from one another. In the following description, a data set identified with the data set identification information D is sometimes referred to as data set D.

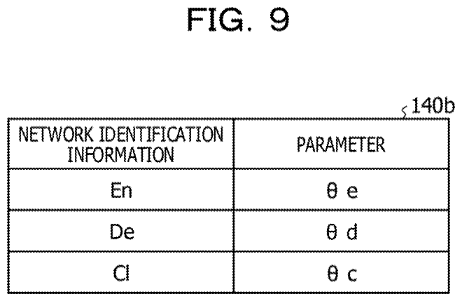

The parameter table 140b is a table that retains parameters of the encoder 50a, the decoder 50b, and the classifier 60. FIG. 9 is a view depicting an example of a data structure of a parameter table. As depicted in FIG. 9, the parameter table 140b associates network identification information and parameters. The network identification information is information for identifying the encoder 50a, the decoder 50b, and the classifier 60. For example, the network identification information “En” indicates the encoder 50a. The network identification information “De” indicates the decoder 50b. The network identification information “Cl” indicates the classifier 60.

The encoder 50a, the decoder 50b, and the classifier 60 correspond to a neural network (NN). The NN is structured such that it includes a plurality of layers, in each of which a plurality of nodes are included and are individually coupled by an edge. Each layer has a function called activation function and a bias value, and each node has a weight. In the description of the present working example, a bias value, a weight and so forth set to an NN are correctively referred to as “parameter.” The parameter of the encoder 50a is represented as a parameter θe. The parameter of the decoder 50b is represented as a parameter θd. The parameter of the classifier 60 is represented as a parameter θc.

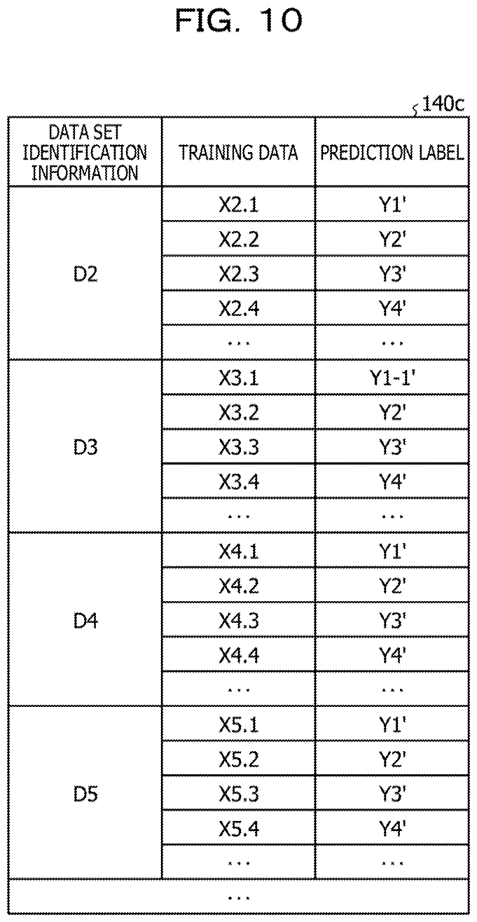

The prediction label table 140c is a table into which, when a data set without a label is inputted to the encoder 50a, a label (prediction label) to be outputted from the classifier 60 is stored. FIG. 10 is a view depicting an example of a data structure of a prediction label table. As depicted in FIG. 10, the prediction label table 140c associates data set identification information, training data, and prediction labels with one another.

Referring back to FIG. 7, the controller 150 includes an acquisition unit 150a, a feature value generation unit 150b, a selection unit 150c, a learning unit 150d, and a prediction unit 150e. The controller 150 may be implemented by a central processing unit (CPU), a micro processing unit (MPU) or the like. Further, the controller 150 may be implemented also by hard wired logics such as an application specific integrated circuit (ASIC) or a field programmable gate array (FPGA).

The acquisition unit 150a is a processor that acquires information of the learning data table 140a from an external apparatus or the like. The acquisition unit 150a stores the acquired information of the learning data table 140a into the learning data table 140a.

The feature value generation unit 150b is a processor that inputs two data sets having natures different from each other to the encoder 50a and generates a distribution of feature values of one of the data sets (hereinafter referred to as first data set) and a distribution of feature values of the other data set (hereinafter referred to as second data set). The feature value generation unit 150b outputs the information of the feature values of the first data set and the distribution of the feature values of the second data set to the selection unit 150c. In the following, an example of processing of the feature value generation unit 150b is described.

The feature value generation unit 150b executes the encoder 50a to set the parameter θe stored in the parameter table 140b to the encoder 50a. The feature value generation unit 150b acquires a first data set and a second data set having natures different from each other from the learning data table 140a.

The feature value generation unit 150b inputs training data included in the first data set to the encoder 50a and calculates a feature value corresponding to each training data based on the parameter θe to generate a distribution of the feature value of the first data set. Here, the feature value generation unit 150b may perform processing for compressing the dimension of the feature values (processing for changing the axis of the feature values) and so forth to generate a distribution of a plurality of feature values. For example, the feature value generation unit 150b generates a distribution zs1 of feature values of a first number of dimensions, a distribution zs2 of feature values of a second number of dimensions, a distribution zs3 of feature values of a third number of dimensions, and a distribution zs4 of feature values of a fourth number of dimensions.

The feature value generation unit 150b inputs the training data included in the second data set to the encoder 50a to calculate a feature value corresponding to each training data based on the parameter θe to generate a distribution of the feature values of the second data set. Here, the feature value generation unit 150b may generate a distribution of a plurality of feature values by performing processing for compressing the dimension of the feature values (processing for changing the axis of feature values). For example, the feature value generation unit 150b generates a distribution zt1 of feature values of a first number of dimensions, a distribution zt2 of feature values of a second number of dimensions, a distribution zt3 of feature values of a third number of dimensions, and a distribution zt4 of feature values of a fourth number of dimensions.

Incidentally, although, when the feature value generation unit 150b generates a distribution of a plurality of feature values, it may perform compression, conversion and so forth of the dimension, it may other generate a distribution of a plurality of feature values by performing processing simply for the decomposition into feature values for each axis. For example, the feature value generation unit 150b decomposes one three-dimensional value of [(1, 2, 3)] into three one-dimensional feature values of [(1), (2), (3)], Further, the feature value generation unit 150b may decompose a feature value using principal component analysis or independent component analysis as different processing for the decomposition.

The selection unit 150c is a processor that compares a distribution of feature values of a first data set and a distribution of feature values of a second data set with each other to select a feature value with regard to which partial coincidence is indicated between the distributions. The selection unit 150c outputs each feature value with regard to which partial coincidence is indicated and each feature value with regard to which partial coincidence is not indicated to the learning unit 150d. In the following description, a feature value with regard to which partial coincidence is indicated is referred to as “feature value U.” A feature value with regard to which partial coincidence is not indicated is referred to as “feature value V.”

Further, the selection unit 150c outputs a feature value having a correlation to the first feature value from among the feature values included in the same data set to the learning unit 150d. In the following description, a feature value having a correlation with a feature value U is suitably referred to as “feature value U′” from among the feature values included in the same data set. In the case where the feature value U and the feature value U′ are not specifically distinguished from each other, each of them is referred to simply as feature value U.

Processing of the selection unit 150c is described with reference to FIG. 2. Here, description is given using, as an example, the distribution of the feature value Zs of the first data set and the distribution of the feature value Zt of the second data set. The distribution of the feature value Zs includes distributions of the feature values zs1 to zs4, The feature values zs1 to zs4 individually correspond to feature values when the axis of the feature value Zs is changed. The distribution of the feature value Zt includes distributions of the feature values zt1 to zt4. The feature values zt1 to zt4 individually correspond to feature values when the axis of the feature value Zt is changed.

The selection unit 150c compares the distributions of the feature values zs1 to zs4 and the distributions of the feature values zt1 to zt4 to decide feature values that indicate feature values close to each other. For example, the selection unit 150c decides that distributions of feature values are close to each other in the case where the distance between the centers of gravity of the distributions of the feature values is smaller than a threshold value.

For example, in the case where the distribution of the feature value zs2 and the distribution of the feature value zt2 are close to each other, the selection unit 150c selects the feature value zs2 and the feature value zt2 as the feature value U. In the case where the distribution of the feature value zs3 and the distribution of the feature value zt3 are close to each other, the selection unit 150c selects the feature value zs3 and the feature value zt3 as the feature value U. In the case where the distribution of the feature value zt3 and the distribution of the feature value zt4 are correlated with each other, the selection unit 150c selects the feature value zt4 as the feature value U′.

The selection unit 150c selects the feature values zs2 and zs3 and sets the selected feature values zs2 and zs3 to the feature value Us. The selection unit 150c selects the feature values zt2, zt3, and zt4 and sets the selected feature values zt2, zt3, and zt4 to the feature value Ut.

The selection unit 150c sets the feature values zs1 and zs4 to the feature value V. The selection unit 150c sets the feature value zt1 to the feature value Vt.

The selection unit 150c outputs information of the feature values Us, Ut, Vs, and Vt to the learning unit 150d.

Further, the selection unit 150c compares the distribution of the feature values of the first data set and the distribution of the feature values of the second data set with each other, evaluates a difference between feature values that partly coincide with each other, and outputs a result of the evaluation to the learning unit 150d. In the example described with reference to FIG. 2, the selection unit 150c evaluates an error between the distribution of the feature value zs2 and the distribution of the feature value zt2 and a difference between the distribution of the feature value zs3 and the distribution of the feature value zt3.

The learning unit 150d is a processor that learns parameters of the encoder 50a, the decoder 50b, and the classifier 60 such that the prediction errors and reconstruction errors decrease and the difference between the feature values with regard to which partial coincidence is indicated decreases. In the following, processing of the learning unit 150d is described.

The learning unit 150d executes the encoder 50a, the decoder 50b, and the classifier 60 and sets the parameters θe, θd, and θc stored in the parameter table 140b to the encoder 50a, the decoder 50b, and the classifier 60, respectively.

The learning unit 150d inputs the feature value U acquired from the selection unit 150c to the classifier 60 to calculate a class label based on the parameter c. For example, in the example depicted in FIG. 1, the learning unit 150d inputs the feature value Us to the classifier 60 to calculate a class label Ys′ based on the parameter θc.

The learning unit 150d evaluates, in the case where the data set corresponding to the feature value U is a data set with a label, a prediction error between the class label of the feature value U and the correct answer label. For example, the learning unit 150d evaluates a square error of the class label (probability of the class label) and the correct answer label as a prediction error.

The learning unit 150d inputs information of a combination of the feature value V acquired from the selection unit 150c and the class label of the feature value U to the decoder 50b to calculate reconstruction data based on the parameter θd. For example, in the example depicted in FIG. 1, the learning unit 150d inputs information of a combination of the feature value Vs and the class label Ys′ of the feature value Us to the decoder 50b to calculate reconstruction data Xs′ based on the parameter θd.

The learning unit 150d evaluates a reconstruction error between the training data corresponding to the feature value V and the reconstruction data. For example, the learning unit 150d evaluates a square error of the training data corresponding to the feature value V and the reconstruction data as a reconstruction error.

The learning unit 150d learns the parameters θe, θd, and θc by an error back propagation method such that the “prediction error,” “reconstruction error,” and “difference of the feature values with regard to which partial coincidence is indicated” determined by the processing described above may individually be minimized.

The feature value generation unit 150b, the selection unit 150c, and the learning unit 150d execute the processing described above repeatedly until a given ending condition is satisfied. The given ending condition includes conditions for defining convergence situations of the parameters θe, θd, and θc, a learning time number and so forth. For example, in the case where the learning time number becomes equal to or greater than N, in the case where the changes of the parameters θe, θd, and θc become lower than a threshold value, the feature value generation unit 150b, the selection unit 150c, and the learning unit 150d end learning.

The learning unit 150d stores the information of the parameters θe, θd, and θc learned already into the parameter table 140b. The learning unit 150d may display the learned information of the parameters θe, θd, and θc on the display unit 130, or the information of the parameters θe, θd, and θc may be notified to a decision apparatus that performs various decisions.

The prediction unit 150e is a processor that predicts a label of each training data included in a data set without a label. As described below, the prediction unit 150e executes processing in cooperation with the feature value generation unit 150b and the selection unit 150c. For example, when processing is to be started, the prediction unit 150e outputs a control signal to the feature value generation unit 150b and the selection unit 150c.

If the control signal from the prediction unit 150e is accepted, the feature value generation unit 150b executes the following processing. The feature value generation unit 150b acquires a first data set and a second data set having natures different from each other from a plurality of data sets without a label included in the learning data table 140a. The feature value generation unit 150b outputs information of a distribution of feature values of the first data set and a distribution of feature values of the second data set to the selection unit 150c. The other processing relating to the feature value generation unit 150b is similar to the processing of the feature value generation unit 150b described hereinabove.

If the selection unit 150c accepts the control signal from the prediction unit 150e, it executes the following processing. The selection unit 150c compares the distribution of the feature values of the first data set and the distribution of the feature values of the second data set with each other and selects a feature value U with regard to which partial coincidence is indicated. The selection unit 150c outputs the selected feature value U to the prediction unit 150e. The processing of selecting a feature value U by the selection unit 150c is similar to that of the selection unit 150c described hereinabove.

The prediction unit 150e executes the classifier 60 and sets the parameter θc stored in the parameter table 140b to the classifier 60. The prediction unit 150e inputs the feature value U acquired from the selection unit 150c to the classifier 60 to calculate a class label based on the parameter c.

The feature value generation unit 150b, the selection unit 150c, and the prediction unit 150e repeatedly execute the processing described above for the training data of the first data set and the training data of the second data set, and calculate and register a prediction label corresponding to each training data into the prediction label table 140c. Further, the feature value generation unit 150b, the selection unit 150c, and the prediction unit 150e select the other training data of the first data set and the other training data of the second data set and execute the processing described above repeatedly for them. Since the feature value generation unit 150b, the selection unit 150c, and the prediction unit 150e execute such processing as described above, prediction labels to the training data of the data sets without a label are stored into the prediction label table 140c. The prediction unit 150e may use an ending condition such as an execution time number and execute the processing described above until after the ending condition is satisfied.

The prediction unit 150e makes a majority vote for the prediction labels corresponding to the training data of the prediction label table 140c to determine a prediction label. For example, the prediction unit 150e makes a majority vote for prediction labels corresponding to training data X2.n, X3.n, X4.n, X5.n, . . . , Xm.n (n=1, 2, 3, 4, . . . ) to determine a label. In regard to the prediction labels for the training data “X2.1, X3.1, X4.1, X5.1,” three “Y1′” and one “Y1-1′” are found, Therefore, the prediction unit 150e determines that the correct answer label corresponding to the training data “X2.1, X3.1, X4.1, X5.1” is “Y1′,” and registers the decision result into the correct answer label of the learning data table 140a.

Regarding the prediction labels for the training data “X2.2, X32, X4.2, X5.2,” four “Y2′” are found. Therefore, the prediction unit 150e decides that the correct answer label corresponding to the training data “X2.2, X3.2, X4.2, X5.2” is “Y2′” and registers the decision result into the correct answer label of the learning data table 140a.

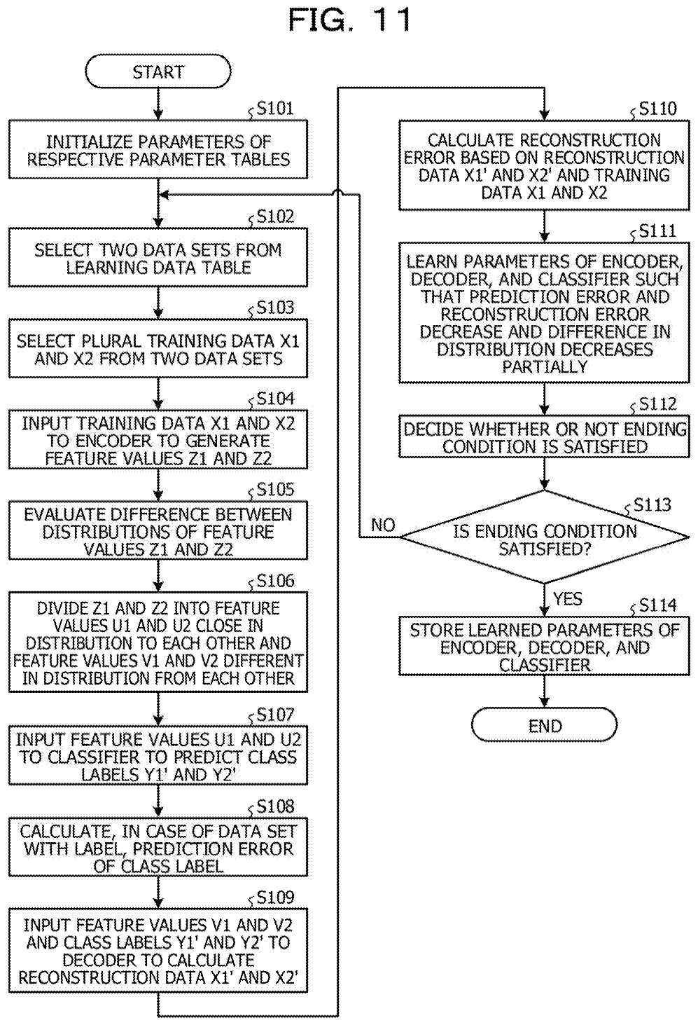

Now, an example of a processing procedure of the learning apparatus 100 according to the present working example is described. FIG. 11 is a flow chart depicting a processing procedure of learning processing of a learning apparatus according to the present working example. As depicted in FIG. 11, the learning apparatus 100 initializes the parameters of the parameter table 140b (step S101). The feature value generation unit 150b of the learning apparatus 100 selects two data sets from within the learning data table 140a (step S102).

The feature value generation unit 150b selects a plurality of training data X1 and X2 from the two data sets (step S103) The feature value generation unit 150b inputs the training data X1 and X2 to the encoder 50a to generate feature values Z1 and Z2 (step S104).

The selection unit 150c of the learning apparatus 100 evaluates a difference between distributions of the feature values Z1 and Z2 (step S105), The selection unit 150c divides the feature values Z11 and Z2 into feature values U1 and U2 that indicate distributions close to each other and feature values V1 and V2 that indicate different distributions from each other (step S106).

The learning unit 150d of the learning apparatus 100 inputs the feature values U1 and U2 to the classifier 60 to predict class labels Y1′ and Y2′ (step S107), In the case where any of the data sets is a data set with a label, the learning unit 150d calculates a prediction error of the class label (step S108).

The learning unit 150d inputs the feature values V1 and V2 and the class labels Y1′ and Y2′ to the decoder 50b to calculate reconstruction data X1′ and X2′ (step S109), The learning unit 150d calculates a reconstruction error based on the reconstruction data X1′ and X2′ and the training data X1 and X2 (step S110).

The learning unit 150d learns the parameters of the encoder 50a, the decoder 50b, and the classifier 60 such that the prediction error and the reconstruction error become small and the difference in distribution partially becomes small (step S111). The learning unit 150d decides whether or not an ending condition is satisfied (step S112). In the case where the ending condition is not satisfied (step S113, No), the learning unit 150d advances its processing to step S102.

On the other hand, in the case where the ending condition is satisfied (step S113, Yes), the learning unit 150d advances the processing to step S114. The learning unit 150d stores the leaned parameters of the encoder 50a, the decoder 50b, and the classifier 60 into the parameter table 140b (step S114).

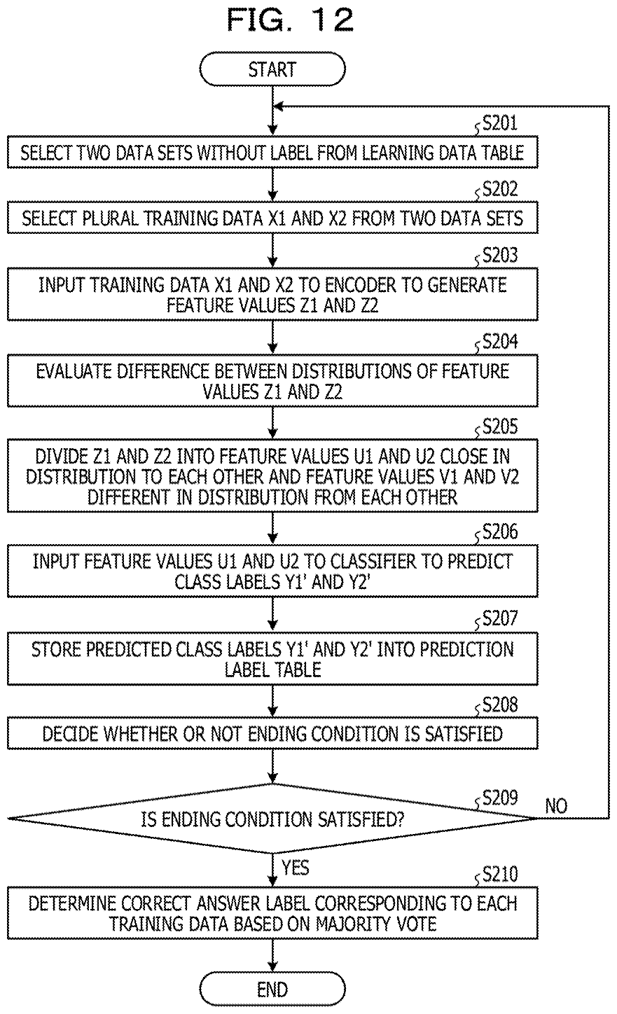

FIG. 12 is a flow chart depicting a processing procedure of prediction processing of a learning apparatus according to the present working example. As depicted in FIG. 12, the feature value generation unit 150b of the learning apparatus 100 selects two data sets without a label from the learning data table 140a (step S201).

The feature value generation unit 150b selects a plurality of training data X1 and X2 from the two data sets (step S202). The feature value generation unit 150b inputs the training data X1 and X2 to the encoder 50a to generate feature values Z1 and Z2 (step S203).

The selection unit 150c of the learning apparatus 100 evaluates a difference between the distributions of the feature values Z1 and Z2 (step S204). The selection unit 150c divides the feature values Z1 and Z2 into feature values U1 and U2 that indicate distributions close to each other and feature values V1 and V2 that indicate distributions different from each other (step S205).

The prediction unit 150e of the learning apparatus 100 inputs the feature values U1 and U2 to the classifier 60 to predict class labels Y1′ and Y2′ (step S206), The prediction unit 150e stores the predicted class labels Y1′ and Y2′ into the prediction label table 140c (step S207). The prediction unit 150e decides whether or not an ending condition is satisfied (step S208).

In the case where the ending condition is not satisfied (step S209, No), the prediction unit 150e advances its processing to step S201. In the case where the ending condition is satisfied (step S209, Yes), the prediction unit 150e determines a correct answer label corresponding to each training data by majority vote (step S210).

Now, advantageous effects of the learning apparatus 100 according to the present working example are described. The learning apparatus 100 compares a plurality of sets of distributions of feature values obtained by inputting one of data sets of the transfer source and the transfer destination to the encoder 50a with each other and inputs only feature values with regard to which partial coincidence is indicated to the classifier 60 to perform learning. Since this allows sharing of information of feature values useful for labeling between data sets, the accuracy in transfer learning may be improved.

The learning apparatus 100 inputs the feature values obtained by excluding the feature values with regard to which partial coincidence is indicated from the feature values of the first data set and the feature values of the second data set and the prediction labels to the decoder to calculate reconstruction data. Further, the learning apparatus 100 learns the parameters θe, θd, and θc such that the reconstruction error between the training data and the reconstruction data becomes small. This make it possible to adjust the classifier 60 such that information of a feature value that is not useful for labeling between data sets is not used.

The learning apparatus 100 learns the parameter θe of the encoder such that the distribution of the feature values of the first data set and the distribution of the feature values of the second data partly coincide with each other. This makes it possible for specific data sets to share information of feature values that are useful for labeling but do not exist between other data sets.

The learning apparatus 100 repeatedly executes the processing of predicting a class label obtained by selecting two data sets without a label and inputting feature values U corresponding to the data sets to the classifier 60 and determines a correct answer label of the data sets by the majority vote and so forth for class labels. This makes it possible to generate a correct answer label of the data set of the transfer destination.

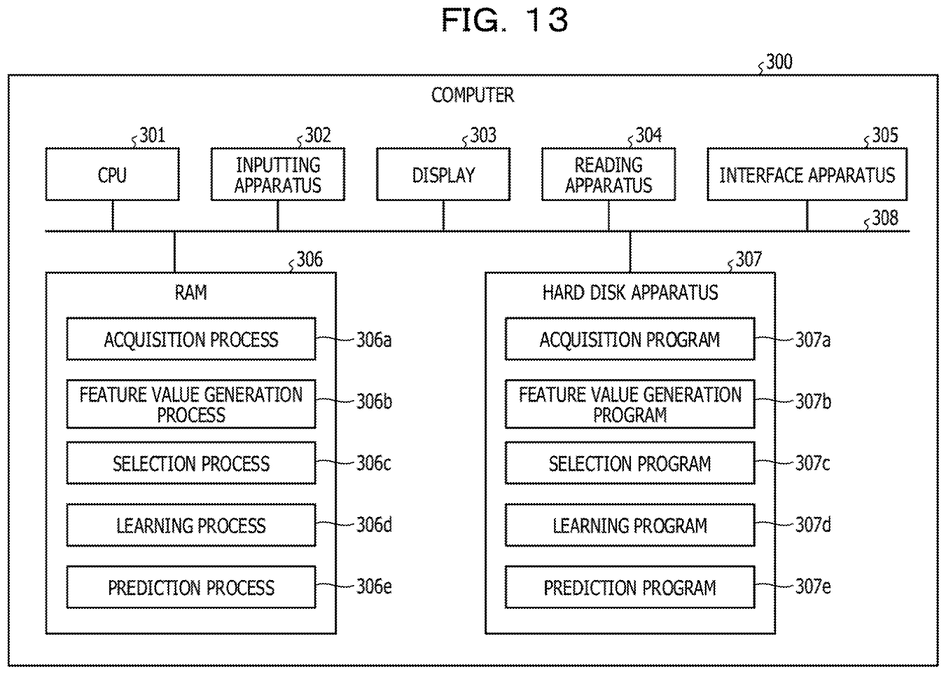

Now, an example of a hardware configuration of a computer that implements functions similar to those of the learning apparatus 100 indicated by the present working example is described. FIG. 13 is a view depicting an example of a hardware configuration of a computer that implements functions similar to those of a learning apparatus according to the present working example.

As depicted in FIG. 13, the computer 300 includes a CPU 301 that executes various arithmetic operation processing, an inputting apparatus 302 that accepts an input of data from a user, and a display 303. The computer 300 further include a reading apparatus 304 that reads a program and so forth from a storage medium and an interface apparatus 305 that performs transfer of data to and from an external apparatus or the like through a wired or wireless network. The computer 300 further includes a RAM 306 that temporarily stores various kinds of information, and a hard disk apparatus 307. The components 301 to 307 are coupled to a bus 308.

The hard disk apparatus 307 includes an acquisition program 307a, a feature value generation program 307b, a selection program 307c, a learning program 307d, a prediction program 307e. The CPU 301 reads out the acquisition program 307a, the feature value generation program 307b, the selection program 307c, the learning program 307d, and the prediction program 307e and deploys them into the RAM 306.

The acquisition program 307a functions as an acquisition process 306a. The feature value generation program 307b functions as a feature value generation process 306b, The selection program 307c functions as a selection process 306c, The learning program 307d functions as a learning process 306d. The prediction program 307e functions as a prediction process 306e.

Processing of the acquisition process 306a corresponds to processing of the acquisition unit 150a. Processing of the feature value generation process 306b corresponds processing of the feature value generation unit 150b. Processing of the selection process 306c corresponds to processing of the selection units 150c and 250c, Processing of the learning process 306d corresponds to processing of the learning unit 150d. Processing of the prediction process 306e corresponds to processing of the prediction unit 150e.

The programs 307a to 307e may not necessarily have been stored in the hard disk apparatus 307 from the beginning. For example, the programs may be stored in a “portable physical medium” to be inserted into the computer 300 such as a flexible disk (FD), a compact disc (CD)-ROM, a digital versatile disc (DVD) disk, a magneto-optical disk, or an integrated circuit (IC) card such that the computer 300 reads out and executes the programs 307a to 307e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A learning method executed by a computer, the learning method comprising:
inputting a first data set being a data set of transfer source and a second data set being one of data sets of transfer destination to an encoder to generate first distributions of feature values of the first data set and second distributions of feature values of the second data set;
selecting one or more feature values from among the feature values so that, for each of the one or more feature values, a first distribution of the feature value of the first data set is similar to a second distribution of the feature value of the second data set;
inputting the one or more feature values to a classifier to calculate prediction labels of the first data set; and
learning parameters of the encoder and the classifier such that the prediction labels of the first data set approach correct answer labels of the first data set.

2. The learning method according to claim 1, the learning method further comprising:
predicting a label corresponding to the second data set of the transfer destination based on the calculated prediction labels of the first data set.

3. The learning method according to claim 1, the learning method further comprising:
inputting a feature value remaining where, from the feature value of the first data set and the feature value of the second data set, the one or more feature values is excluded and the prediction labels to a decoder to calculate reconstruction data.

4. The learning method according to claim 3, the learning method further comprising:
learning a parameter of the encoder, a parameter of the decoder, and a parameter of the classifier such that an error between data inputted to the encoder and the reconstruction data decreases.

5. The learning method according to claim 1, the learning method further comprising:
learning a parameter of the encoder such that the first distribution of the feature value of the first data and the second distribution of the feature value of the second data set partially coincide with each other.

6. The learning method according to claim 1,
wherein the inputting process includes inputting a group of the data set of the transfer source and the data set of the transfer destination or a group of two data sets of transfer destinations different from each other to the encoder to calculate a distribution of the feature value of the first data set and a distribution of the feature value of the second data set.

7. A non-transitory computer-readable storage medium storing a program that causes a computer to execute process, the processing comprising:
inputting a first data set being a data set of transfer source and a second data set being one of data sets of transfer destination to an encoder to generate first distributions of feature values of the first data set and second distributions of feature values of the second data set;
selecting one or more feature values from among the feature values so that, for each of the one or more feature values, a first distribution of the feature value of the first data set is similar to a second distribution of the feature value of the second data set;
inputting the one or more feature values to a classifier to calculate a prediction labels of the first data set; and
learning parameters of the encoder and the classifier such that the prediction labels of the first data set approach correct answer labels of the first data set.

8. A learning apparatus, comprising:
a memory; and
a processor coupled to the memory and the processor configured to:
input a first data set being a data set of transfer source and a second data set being one of data sets of transfer destination to an encoder to generate first distributions of feature values of the first data set and second distributions of feature values of the second data set,
select one or more feature values from among the feature values so that, for each of the one or more feature values, a first distribution of the feature value of the first data set is similar to a second distribution of the feature value of the second data set,
input the one or more feature values to a classifier to calculate prediction labels of the first data set, and
learn parameters of the encoder and the classifier such that the prediction labels of the first data set approach correct answer labels of the first data set.

9. The learning apparatus, according to claim 8, wherein the processor is configured to:
predict a label corresponding to the second data set of the transfer destination based on the calculated prediction labels of the first data set.

10. The learning apparatus, according to claim 8, wherein the processor is configured to:
input a feature value remaining where, from the feature value of the first data set and the feature values of the second data set, the one or more feature values is excluded and the prediction labels to a decoder to calculate reconstruction data.

11. The learning apparatus, according to claim 10, wherein the processor is configured to:
learn a parameter of the encoder, a parameter of the decoder, and a parameter of the classifier such that an error between data inputted to the encoder and the reconstruction data decreases.

12. The learning apparatus, according to claim 8, wherein the processor is configured to:
learn a parameter of the encoder such that the first distribution of the feature value of the first data and the second distribution of the feature value of the second data set partially coincide with each other.
